(19) United States
(12) Patent Application Publication
(10) Pub. No.: US 2019/0199891 A1
(43) Pub. Date: Jun. 27, 2019

(54) CIRCUIT APPLIED TO DISPLAY APPARATUS AND ASSOCIATED SIGNAL PROCESSING METHOD

(71) Applicant: MStar Semiconductor, Inc., Hsinchu Hsien (TW)

(72) Inventors: Tzu-Yi Yang, Hsinchu County (TW); Ko-Yin Lai, Hsinchu County (TW); TAI-LAI TUNG, Hsinchu County (TW)

(21) Appl. No.: 16/132,923

(22) Filed: Sep. 17, 2018

(30) Foreign Application Priority Data
Dec. 21, 2017 (TW) 106145007

(51) Int. Cl. H04N 5/21; G09G 3/20

(52) U.S. Cl. CPC H04N 5/21; G09G 3/2088

(57) ABSTRACT

A circuit applied to a display apparatus includes a first noise variance estimation circuit, an impulsive interference determination circuit, a second noise variance circuit and a selection circuit. The first noise variance estimation circuit calculates a first noise variance of an input signal. The impulsive interference determination circuit determines whether the input signal has impulsive interference according to the first noise variance to generate a detection result. The second noise variance estimation circuit calculates a second noise variance based on the input signal. The selection circuit selectively outputs one of the first noise variance and the second noise variance according to the detection result.

This application claims the benefit of Taiwan application Serial No. 106145007, filed Dec. 21, 2017, the subject matter of which is incorporated herein by reference.

### BACKGROUND OF THE INVENTION

### Field of the Invention

The invention relates to signal processing in a display apparatus, and more particularly to an impulsive interference detection circuit applied to a display apparatus and an associated signal processing method.

### Description of the Related Art

In the Digital Video Broadcasting-Second Generation Terrestrial (DVB-T2) standard, impulsive interference is considered as an issue severely affecting image display. Impulsive interference has large sudden and periodical amplitudes, and is usually generated by factors in the ambient environment, e.g., an operating washing machine or dishwasher, and a fast automobile passing by. Due to the influence of the impulsive interference, distortion may be caused by offsets in noise variances during a signal-to-noise (SNR) calculation process performed by an SNR calculation circuit, leading to subsequent signal processing errors.

### SUMMARY OF THE INVENTION

Therefore, it is an object of the present invention to provide a method for calculating a noise variance, wherein the method is capable of outputting more accurate noise variances even in the presence of impulsive interference so as to resolve issues of the prior art.

A circuit applied to a display apparatus is disclosed according to an embodiment of the present invention. The circuit includes a first noise variance estimation circuit, an impulsive interference determination circuit, a second noise variance estimation circuit and a selection circuit. The first noise variance estimation circuit calculates a first noise variance of an input signal. The impulsive interference determination circuit determines whether the input signal has impulsive interference according to the first noise variance to generate a detection result. The second noise variance estimation circuit calculates a second noise variance based on the input signal. The selection circuit selectively outputs one of the first noise variance and the second noise variance according to the selection result.

A signal processing method applied to a display apparatus is disclosed according to another embodiment of the present invention. The signal processing method includes: calculating a first noise variance of an input signal; determining whether the input signal has impulsive interference according to the first noise variance to generate a detection result; calculating a second noise variance of the input signal; and selectively outputting one of the first noise variance and the second noise variance according to the detection result.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a block diagram of a circuit applied to a display apparatus according to an embodiment of the present invention;

FIG. 2 is a block diagram of a circuit applied to a display apparatus according to another embodiment of the present invention;

FIG. 3 is a block diagram of a first noise variance estimation circuit according to an embodiment of the present invention;

FIG. 4 is a detailed block diagram of the first noise variance estimation circuit according to an embodiment of the present invention;

FIG. 5 is a schematic diagram of a frequency-domain signal;

FIG. 6 is a schematic diagram of a receiver according to an embodiment of the present invention; and

FIG. 7 is a flowchart of a signal processing method applied to a display apparatus according to an embodiment of the present invention.

### DETAILED DESCRIPTION OF THE INVENTION

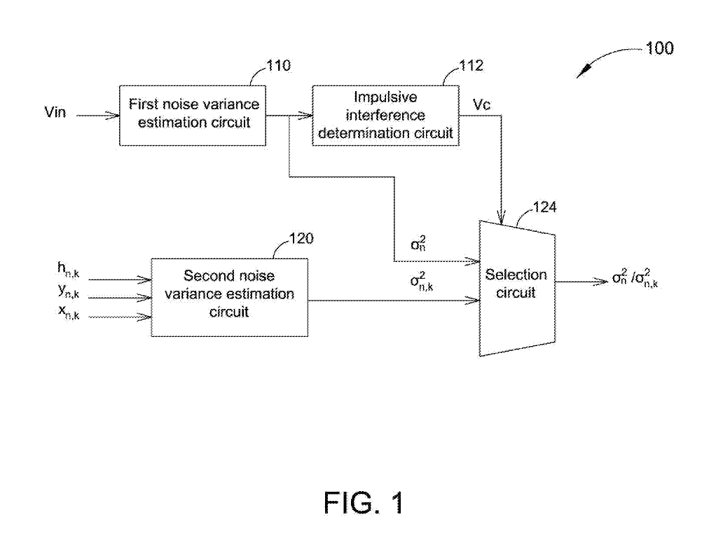

FIG. 1 shows a block diagram of a circuit 100 applied to a display apparatus according to an embodiment of the present invention. As shown in FIG. 1, the circuit 100 in FIG. 1 includes a first noise variance estimation circuit 110, an impulsive interference determination circuit 112, a second noise variance estimation circuit 120 and a selection circuit 124. In this embodiment, the circuit 100 is provided in a Digital Video Broadcasting-Second Generation Terrestrial (DVB-T2)-conforming receiver of a television or a set-top box (STB), and a signal received by the receiver adopts an orthogonal frequency-division multiplexing (OFDM) modulation scheme.

In the operation of the circuit 100, the first noise variance estimation circuit 110 calculates a first noise variance σₙ² based on an input signal Vin, and the impulsive interference determination circuit 112 determines whether the input signal Vin has impulsive interference according to the first noise variance σₙ². More specifically, in this embodiment, the input signal Vin is a frequency-domain signal, which includes multiple symbols, and the first noise variance estimation circuit 110 calculates the first noise variance σₙ² based on multiple pilot cells in each symbol, where the subscript “n” represents the symbol number. Associated implementation details are to be given shortly in the following disclosure. After the first noise variance σₙ² has been calculated, the impulsive interference determination circuit 112 determines whether the first noise variance σₙ² is greater than a threshold to determine whether the input signal Vin has impulsive interference to generate a detection result Vc. For example, if the first noise variance is greater than the threshold, it is determined that the input signal Vin has impulsive interference, otherwise it is determined that the input signal Vin does not have impulsive interference.

The second noise variance estimation circuit 120 real-time calculates a second noise variance σ_{n,k}² according to multiple observation values y_{n,k} of the input signal Vin, an estimated channel response h_{n,k}, and multiple ideal values x_{n,k} of the input signal Vin, wherein the subscript “n” represents the symbol number and the subscript “k” represents the carrier number. In one embodiment, the calculation method of the second noise variance σ_{n,k}² is: σ_{n,k}²=|N_{n,k}|²|y_{n,k}−h_{n,k}·x_{n,k}|², where N_{n,k} is a noise variance statistical value of the k^{th} carrier of the n^{th} symbol.

It should be noted that, because the first noise variance σₙ² is calculated in regard to determining whether the input signal Vin has impulsive interference, the first noise variance σₙ² is capable of fully reflecting the influence of impulsive interference. In contrast, the second noise variance σ_{n,k}² is calculated in regard to the difference between the observation value y_{n,k} and the product of the estimated channel response h_{n,k} and the ideal value x_{n,k} of the k^{th} carrier of the n^{th} symbol, the second noise variance σ_{n,k}² does not actually reflect the influence of impulsive interference. Therefore, the selection circuit 124 in this embodiment may select the first noise variance σₙ² or the second noise variance σ_{n,k}² according to the detection result Vc, and provides the selected noise variance for subsequent use. More specifically, when the detection result Vc indicates the presence of impulsive interference in the input signal Vin, the selection circuit 124 outputs the first noise variance σₙ²; when the detection result Vc indicates that the input signal Vin does not have impulsive interference, the selection circuit 124 outputs the second noise variance σ_{n,k}².

As described above, since the selection circuit 124 may select the more appropriate noise variance according to whether the input signal Vin has impulsive interference, the issue of the prior art, in which distortion caused by offsets in noise variances during the SNR calculation process results in subsequent signal processing errors, is resolved.

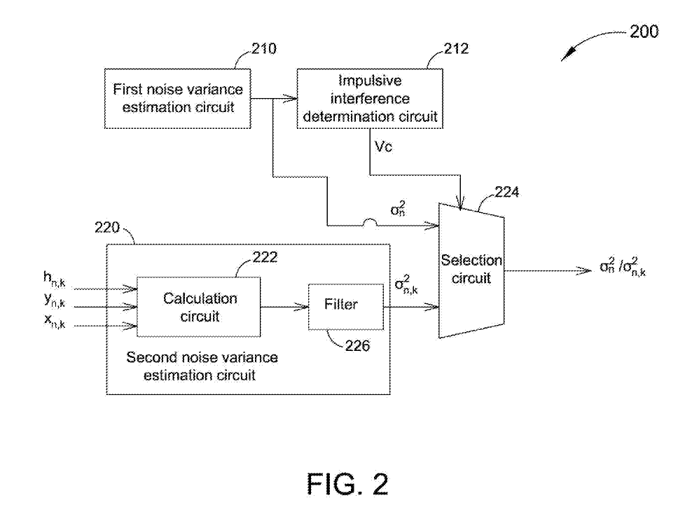

FIG. 2 shows a block diagram of a circuit 200 applied to a display apparatus according to another embodiment of the present invention. The difference of the circuit 200 from the circuit 100 in FIG. 1 is that, a second noise variance estimation circuit 220 includes a calculation circuit 222 and a filter 226. The operation of the calculation circuit 222 is identical to that of the second noise variance estimation circuit 120 in FIG. 1, and the operations of the other components are identical to those having the same names. Thus, description in regard to only the filter 226 is given below.

In the circuit 200, the filter 226 may perform a filtering operation (i.e., smoothing processing) on the noise variance calculated by the calculation circuit 222. For example, the second noise variance σ_{n,k}² may be calculated according to a calculation method: σ_{n,k}²=σ_{n-1,k}²+α·(σ_{n,k}²−σ_{n-1,k}²), where α may be any value between 0 and 1, σ_{n,k}² is the noise variance outputted by the filter 226 for the k^{th} carrier of the n^{th} symbol, σ_{n-1,k}² is the noise variance outputted by the filter 226 for the k^{th} carrier of the (n−1)^{th} symbol, and σ_{n,k}²′ is the noise variance outputted by the calculation circuit 222 for the k^{th} carrier of the n^{th} symbol. In another embodiment, the impulsive interference determination circuit 212 may also send the detection result Vc to the filter 226, and the filter 226 is turned off when the indication result Vc indicates that the input signal Vc has impulsive interference.

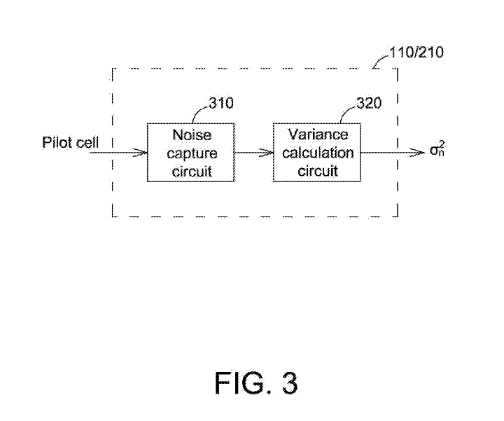

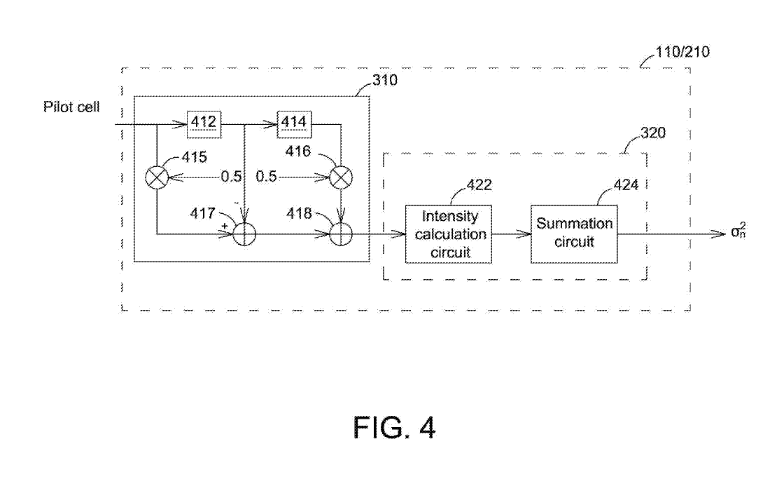

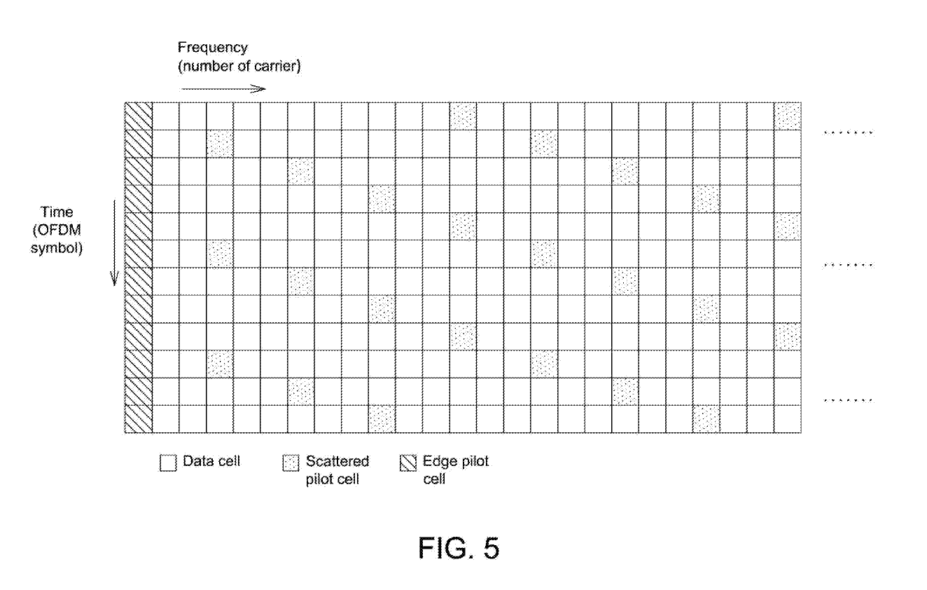

FIG. 3 shows a block diagram of the first noise variance estimation circuit 110/210 according to an embodiment of the present invention. As shown in FIG. 3, the first noise variance estimation circuit 110/210 includes a noise capture circuit 310 and a variance calculation circuit 320. FIG. 4 shows a detailed block diagram of the first noise variance estimation circuit 110/210 according to an embodiment. In this embodiment, the noise capture circuit 310 is implemented by a filter. In FIG. 4 and the following description, the noise capture circuit 310 is a second-order filter as an example for illustrations. Thus, the noise capture circuit 310 of this embodiment includes two delay circuits 412 and 414, two multipliers 415 and 416 (having a multiplier of 0.5), and two adders 417 and 418; however, the present invention is not limited to the above. In other embodiments, the noise capture circuit 310 may also be implemented as a filter of an order higher than the second order. The variance calculation circuit 320 includes an intensity calculation circuit 422 and a summation circuit 424. FIG. 5 shows a schematic diagram of the input signal Vin (a frequency-domain signal) in this embodiment, where the vertical axis represents OFDM symbols at different time points, and each row represents one OFDM symbol, and each OFDM symbol includes an edge pilot cell, multiple data cells and multiple scatter pilot cells; the horizontal axis represents the frequency, and the columns respectively correspond to different carriers. In this embodiment, the first noise variance estimation circuit 110/210 sequentially generates the variance statistical information of noise of pilot cells of each symbol (i.e., the OFDM symbol at each row in FIG. 5), and the impulsive interference determination circuit 112/212 accordingly generates a detection result. Operation details of each of the circuit components are given below with reference to equations.

The pilot cells of the input signal Vin (a frequency-domain signal) are captured by a pilot cell capture circuit, and the channel frequency response thereof may be represented as Ĥ_{n,k}=H_{n,k}+N_{n,k}, where the subscript “n” represents the sequence number of the symbol (i.e., which row in FIG. 5), and the subscript “k” represents the number of carrier (i.e., which column in FIG. 5), H_{n,k} represents the channel frequency response of the pilot cells, N_{n,k} represents of noise of the pilot cells, and the noise includes additive white Gaussian noise (AWGN), inter-carrier interference (ICI), adjacent-channel interference (ACI), co-channel interference (CCI) and impulsive interference. Further, the channel impulse response of the pilot cells may be represented as:

$$h ( t ) = {\sum }_{m = 0}^{M - 1} δ ( t - {τ}_{m} ) \cdot {e}^{j {θ}_{m}} ,$$

where δ(t) is a delta function, τₘ and θₘ are delay and phase of the corresponding path, and M is the quantity of paths. The noise capture circuit 310 may be represented as: Hₖ^{diff}=δ[k]−0.5·(δ[k+1]+δ[k−1]), and is

$${h}^{diff} ( t ) = 1 - cos ( 2 π \frac{t}{{T}_{sp}} )$$

on a corresponding time domain. Thus, the output from the noise capture circuit 310 in FIG. 4 may be represented as:

$${\hat{H}}_{n , k} - 0.5 ( {\hat{H}}_{n , k - 1} + {\hat{H}}_{n , k + 1} ) = ( δ [ k ] - 0.5 \cdot ( δ [ k + 1 ] + δ [ k - 1 ] ) ) ⊗ {\hat{H}}_{n , k} = {H}_{k}^{diff} ⊗ {\hat{H}}_{n , k} = {H}_{k}^{diff} ⊗ ( {H}_{n , k} + {n}_{n , k} ) = {H}_{k}^{diff} ⊗ {H}_{n , k} + {H}_{k}^{dif} ⊗ {N}_{n , k} \approx {H}_{k}^{dif} ⊗ {N}_{n , k} = {N}_{n , k} - 0.5 ( {N}_{n , k + 1} + {N}_{n , k - 1} )$$

In brief, because adjacent pilot cells theoretically have substantially the same signal intensity, the data outputted by the noise capture circuit 310 each time is a difference between noise components of one pilot cell and an average of noise components of two adjacent pilot cells on the left and right of the pilot cell.

The variance calculation circuit 320 calculates the variance statistical information of noise of pilot cells of each symbol. More specifically, the intensity calculation circuit 422 calculates a discrepancy level between differences of noise captured by the noise capture circuit 310; for example, the intensity calculation circuit 422 squares the output from the noise capture circuit 310 as its output, and the summation circuit 424 sums up the output from the intensity calculation circuit 422 to generate the first noise variance. More specifically, calculation equations of the filter 310, the intensity calculation circuit 422 and the summation circuit 424 may be represented as follows:

$${σ}_{n}^{2} \approx \frac{2}{3} \frac{1}{K - 2} {\sum }_{k = 1}^{K - 2} {\vert {N}_{n , k} - \frac{1}{2} ( {N}_{n , k - 1} + {N}_{n , k + 1} ) \vert}^{2} = \frac{2}{3} \frac{1}{K - 2} {\sum }_{k = 1}^{K - 2} \{ {\vert {N}_{n , k} \vert}^{2} + \frac{1}{4} ( {\vert {N}_{n , k - 1} \vert}^{2} + {\vert {N}_{n , k + 1} \vert}^{2} ) - Re \{ {N}_{n , k} ( {N}_{n , k - 1}^{*} + {N}_{n , k + 1}^{*} \} + \frac{1}{2} {N}_{n , k - 1} {N}_{n , k + 1}^{*} \} \}$$

In the above equation, “K−2” represents the quantity of pilot cells calculated, and

$$“ \frac{2}{3} \frac{1}{K - 2} ”$$

is an adjustment ratio. If the noise variance of each pilot cell is defined as σ_{n,k}² ≡E{|n_{n,k}|²}, the above calculation equation may be represented as follows:

$$E \{ {\hat{σ}}_{n}^{2} \} = \frac{2}{3} \frac{1}{K - 2} {\sum }_{k = 1}^{K - 2} E \{ {\vert {n}_{n , k} \vert}^{2} + \frac{1}{4} ( {\vert {n}_{n , k - 1} \vert}^{2} + {\vert {n}_{n , k + 1} \vert}^{2} ) - Re \{ {n}_{n , k} ( {n}_{n , k - 1}^{*} + {n}_{n , k + 1}^{*} ) + \frac{1}{2} {n}_{n , k - 1} {n}_{n , k + 1}^{*} \} \} = \frac{2}{3} \frac{1}{K - 2} {\sum }_{k = 1}^{K - 2} ( {σ}_{n , k}^{2} + \frac{1}{4} {σ}_{n , k - 1}^{2} + \frac{1}{4} {σ}_{n , k + 1}^{2} ) = \frac{1}{K - 2} {\sum }_{k = 0}^{K - 1} {σ}_{n , k}^{2} - \frac{1}{6 ( K - 2 )} ( 5 {σ}_{n , 0}^{2} + 5 {σ}_{n , K - 1}^{2} + {σ}_{n , 1}^{2} + {σ}_{n , K - 2}^{2} )$$

The noise variance of the symbol is again defined as the average of the variance of each pilot cell, and the noise variance of the symbol may be represented as:

$${\overline{σ}}_{n}^{2} ≡ \frac{1}{K} {\sum }_{k = 0}^{K - 1} {σ}_{n , k}^{2} .$$

If the value of K is large enough, the output from the first noise variance estimation circuit 110/210 may be represented as:

$$E \{ {\hat{σ}}_{n}^{2} \} = \frac{K}{K - 2} ( \frac{1}{K} {\sum }_{k = 0}^{K - 1} {σ}_{n , k}^{2} ) - \frac{1}{6 ( K - 2 )} ( 5 {σ}_{n , 0}^{2} + 5 {σ}_{n , K - 1}^{2} + {σ}_{n , 1}^{2} + {σ}_{n , K - 2}^{2} ) \to \frac{1}{K} {\sum }_{k = 0}^{K - 1} {σ}_{n , k}^{2} = {\overline{σ}}_{n}^{2}$$

As described above, the first noise variance estimation circuit 110/210 is capable of outputting the noise variance average of the carrier frequencies in each symbol as the first noise variance.

Noise of each pilot cell includes normally occurring noise and noise caused by impulsive interference, wherein the normally occurring noise may be AWGN, ICI, ACI and CCI, and so the noise variance of each symbol outputted by the first noise variance estimation circuit 110/210 also includes normally occurring noise and impulsive interference. However, in the above calculation process, particularly noticeable values are generated based on sporadic characteristics of impulsive interference. Thus, the method of the embodiment is capable of accurately calculating the noise variance (i.e., the first noise variance σₙ²), and is specifically capable of determining whether each symbol has impulsive interference by determining whether the first noise variance is greater than a threshold.

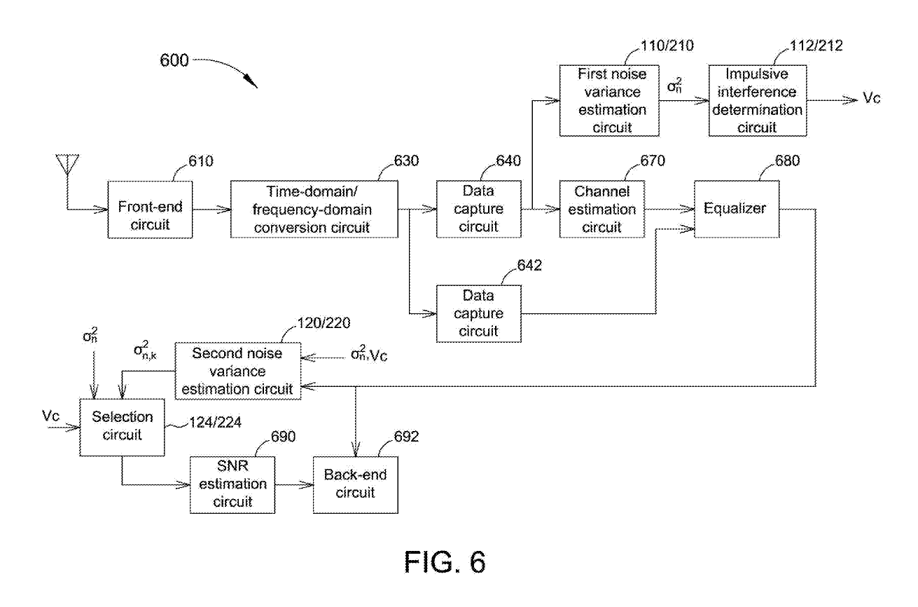

The circuits 100 and 200 shown in FIG. 1 and FIG. 2 may be applied in a receiver. FIG. 6 shows a schematic diagram of a receiver 600 according to an embodiment of the present invention. As shown in FIG. 6, the circuit 600 includes a front-end circuit 610, a time-domain/frequency-domain conversion circuit 630, a pilot signal capture circuit 640, a data capture circuit 642, a first noise variance estimation circuit 110/120, an impulsive interference detection circuit 112/212, a channel estimation circuit 670, an equalizer 680, a second noise variance estimation circuit 120/220, a selection circuit 124/224, an SNR estimation circuit 690 and a back-end circuit 692. In this embodiment, the receiver 600 processes an analog input signal from an antenna, and generates an output signal to a back-end processing circuit in a television or in an STB so as to play the output signal on a screen.

In the circuit 600, the front-end circuit 610 performs analog-to-digital conversion on the received signal, and filters out adjacent channel interference (ACI) from the digital input signal to generate a digital input signal. The time-domain/frequency-domain conversion circuit 630 converts the digital input signal from a time domain to a frequency domain to generate a frequency-domain signal. The pilot signal capture circuit 640 captures multiple pilot cells (may be edge pilot cells and/or scattered pilot cells) in one symbol. Operation details of the first noise variance estimation circuit 110/210 and the impulsive interference determination circuit 112/212 are similar to those in FIGS. 3 and 4, and are omitted herein. The channel estimation circuit 670 calculates the channel frequency response CE and signal intensity corresponding to the symbol in the frequency-domain signal according to the pilot cells. On the other hand, the data capture circuit 642 captures multiple data cells in the symbol from the frequency-domain signal. The equalizer 680 performs equalization on the multiple data cells according to the channel frequency response calculated by the channel estimation circuit 670 to generate an equalized signal EQ. Operation details of the second noise variance estimation circuit 120/220 are similar to those shown in FIGS. 1 and 2, and the selection circuit 124/224 selectively outputs the first noise variance σₙ² calculated by the first noise variance estimation circuit 110/210 or the second noise variance σ_{n,k}² calculated by the second noise variance estimation circuit 120/220. The SNR estimation circuit 690 performs SNR estimation according to the first noise variance σₙ² or the second noise variance σ_{n,k}² to generate an estimated SNR result. The back-end circuit 692 performs operations such as de-interleaving, demapping and decoding on the equalized signal EQ according to the estimated SNR result.

In one embodiment, the SNR estimation circuit 690 generates the estimated SNR result by using the calculation method below:

$${SNR}_{n , k} = \frac{{S}_{n , k}}{{σ}_{n , k}^{2}} ,$$

where SNR_{n,k} is the SNR of the k^{th} carrier of the n^{th} symbol, and S_{n,k} is the signal intensity of the k^{th} carrier of the n^{th} symbol.

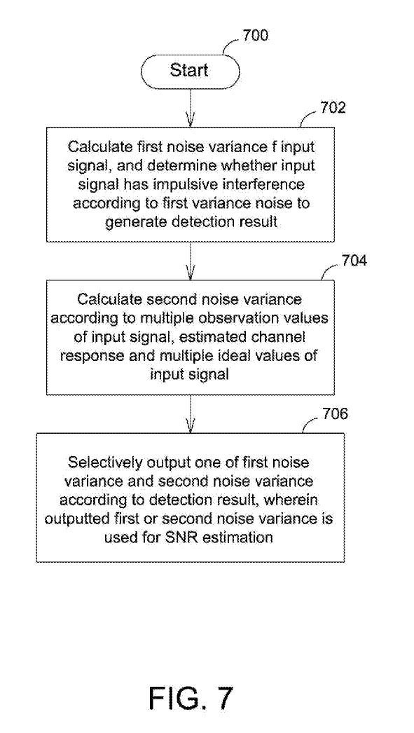

FIG. 7 shows a flowchart of a signal processing method applied to a display apparatus according to an embodiment of the present invention. Referring to FIGS. 1 to 7 and the above disclosure, the process of FIG. 7 includes following steps.

In step 700, the process begins.

In step 702, a first noise variance of an input signal is calculated, and it is determined according to the first noise variance whether the input signal has impulsive interference to generate a detection result.

In step 704, a second noise variance is calculated according to multiple observation values of the input signal, an estimated channel response and multiple ideal values of the input signal.

In step 706, one of the first noise variance and the second noise variance is selectively outputted according to the detection result, wherein the outputted first noise variance or second noise variance is used for performing SNR estimation.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A circuit applied to a display apparatus, comprising:
a first noise variance estimation circuit, calculating a first noise variance of an input signal;
an impulsive interference determination circuit, determining whether the input signal has impulsive interference according to the first noise variance to generate a detection result;
a second noise variance estimation circuit, calculating a second noise variance of the input signal; and
a selection circuit, selectively outputting one of the first noise variance and the second noise variance according to the detection result.

2. The circuit according to claim 1, wherein the second noise variance estimation circuit calculates the second noise variance according to a plurality of observation values of the input signal, an estimated channel response and a plurality of ideal values of the input signal.

3. The circuit according to claim 1, wherein the second noise variance estimation circuit comprises:
a calculation circuit, calculating a plurality of original noise variances according to a plurality of observation values of the input signal, an estimated channel response and a plurality of ideal values of the input signal; and
a filter, coupled to the calculation circuit, performing a filtering process on the plurality of original noise variances to generate the second noise variance.

4. The circuit according to claim 3, wherein when the selection circuit selectively outputs the first noise variance according to the detection result, the second noise variance estimation circuit disables an operation of the filter.

5. The circuit according to claim 1, wherein the input signal is a frequency-domain signal, the frequency-domain signal comprises a plurality of symbols, each of the symbols comprises a plurality of pilot cells; the circuit further comprising:
a pilot cell capture circuit, capturing the plurality of pilot cells in each symbol from the frequency-domain signal;
wherein, the first noise variance estimation circuit generates the first noise variance according to noise intensities of the plurality of pilot cells in each symbol.

6. The circuit according to claim 5, wherein each of the symbols further comprises a plurality of data cells, and the first noise variance estimation circuit generates the first noise variance without considering the noise intensities of the plurality of data cells.

7. The circuit according to claim 5, wherein the first noise variance estimation circuit comprises:
a noise capture circuit, capturing differences between a noise component of each pilot cell and noise components of adjacent pilot cells of the pilot cell; and
a variance calculation circuit, coupled to the noise capture circuit, calculating variance statistical information of noise of a part of the plurality of pilot cells according to the plurality of differences to generate the first noise variance.

8. The circuit according to claim 7, wherein the variance calculation circuit comprises:
an intensity calculation circuit, calculating intensity values of the plurality of differences; and
a summation circuit, coupled to the intensity calculation circuit, accumulating the plurality of intensity values to obtain the variance statistical information.

9. The circuit according to claim 1, wherein the impulsive interference determination circuit determines whether the input signal has impulsive interference according to a value of the first noise variance to generate the detection result; when the detection result indicates that the input signal has impulsive interference, the selection circuit selectively outputs the first noise variance according to the detection result; and when the detection result indicates that the input signal does not have impulsive interference, the selection circuit selectively outputs the second noise variance according to the detection result.

10. The circuit according to claim 1, wherein the input signal is a frequency-domain signal, the frequency-domain signal comprises a plurality of symbols, and each of the symbols comprises a plurality of data cells; the circuit further comprising:
a data capture circuit, capturing the plurality of data cells in each symbol from the frequency-domain signal;
a signal-to-noise (SNR) estimation circuit, coupled to the selection circuit, generating an SNR according to one of the first noise variance and the second noise variance; and
a back-end circuit, coupled to the SNR estimation circuit, performing processing according to the SNR and the plurality of data cells to generate an output signal.

11. A signal processing method applied to a display apparatus, comprising:
calculating a first noise variance of an input signal;
determining whether the input signal has impulsive interference according to the first noise variance to generate a detection result;
calculating a second noise variance of the input signal; and
selectively outputting one of the first noise variance and the second noise variance according to the detection result.

12. The signal processing method according to claim 11, wherein the step of calculating the second noise variance of the input signal comprises:
calculating the second noise variance according to a plurality of observation values of the input signal, an estimated channel response and a plurality of ideal values of the input signal.

13. The signal processing method according to claim 11, wherein the step of calculating the second noise variance of the input signal comprises:
calculating a plurality of original noise variances according to a plurality of observation values of the input signal, an estimated channel response and a plurality of ideal values of the input signal; and
performing a filtering process on the plurality of original noise variances by a filter to generate the second noise variance.

14. The signal processing method according to claim 13, further comprising:
disabling an operation of the filter when the first noise variance is selectively outputted according to the detection result.

15. The signal processing method according to claim 11, wherein the input signal is a frequency-domain signal, the frequency domain signal comprises a plurality of symbols, and each of the symbols comprises a plurality of pilot cells; the signal processing method further comprising:
capturing the plurality of pilot cells in each symbol from the frequency-domain signal;
wherein, the step of generating the first noise variance comprises:
generating the first noise variance according to noise intensities of the plurality of pilot cells in each symbol.

16. The signal processing method according to claim 15, wherein each of the symbols further comprises a plurality of data cells, and the step of generating the first noise variance is performed without considering the noise intensities of the plurality of data cells.

17. The signal processing method according to claim 15, wherein the step of generating the first noise variance according to the plurality of noise intensities of the plurality of pilot cells in each symbol comprises:
capturing differences between a noise component of each pilot cell and noise components of adjacent pilot cells of the pilot cell; and
calculating variance statistical information of noise of a part of the plurality of pilot cells according to the plurality of differences to generate the first noise variance.

18. The signal processing method according to claim 17, wherein the step of calculating the variance statistical information of the noise of the part of the plurality of pilot cells according to the plurality of differences to generate the first noise variance comprises:
calculating intensity values of the plurality of differences; and
accumulating the plurality of intensity values to obtain the variance statistical information.

19. The signal processing method according to claim 11, wherein the step of generating the detection result comprises:
determining whether the input signal has impulsive interference according to a value of the first noise variance to generate the detection result; and
the step of selectively outputting one of the first noise variance and the second noise variance according to the detection result comprises:
when the detection result indicates that the input signal has impulsive interference, selectively outputting the first noise variance according to the detection result; and
when the detection result indicates that the input signal does not have impulsive interference, selectively outputting the second noise variance according to the detection result.

20. The signal processing method according to claim 11, wherein the input signal is a frequency-domain signal, the frequency-domain signal comprises a plurality of symbols, and each of the symbols comprises a plurality of data cells; the signal processing method further comprising:
capturing the plurality of data cells in each symbol from the frequency-domain signal;
generating a signal-to-noise (SNR) ratio according to one of the first noise variance and the second noise variance; and
performing processing according to the SNR and the plurality of data cells to generate an output signal.
